(19) United States
(12) Patent Application Publication
(10) Pub. No.: US 2001/0023556 A1
(43) Pub. Date: Sep. 27, 2001

(54) Actuating drive for a motor vehicle

(76) Inventor: Peter Michel, Kleinrinderfeld (DE)

Correspondence Address: SUGHRUE, MION, ZINN, MACPEAK & SEAS, PLLC, Suite 800, 2100 Pennsylvania Avenue, N.W., WASHINGTON, DC, 20037-3213, US

(21) Appl. No.: 09/750,127

(22) Filed: Dec. 29, 2000

Related U.S. Application Data
(63) Continuation of application No. PCT/DE99/01887, filed on Jun. 29, 1999.

(30) Foreign Application Priority Data
Jun. 30, 1998 (DE) 19829209.0

(51) Int. Cl. E05F 15/08

(52) U.S. Cl. 49/349

(57) ABSTRACT

A driving motor (1) for an actuating drive having improved jamming protection of a closing part, e.g., a window pane (2) of a motor vehicle. The closing part is adjusted via a transmission, e.g., a cable drive drum (3, 4). To avoid over-dimensioning of the driving motor (1), a variable transmission is provided that delivers a substantially constant load on the driving motor (1) over the entire adjustment path of the window pane (2). Thereby, a design of the driving motor (1) to cope with an increased load, which would otherwise be caused when the closing part slides into a closed position, is avoided. In addition, since the closing part approaches the closed position with a lower speed, the closing part is able to brake rapidly, if necessary. This results, e.g., in an improved jamming protection function of the closing part.

This is a Continuation of International Application PCT/DE99/01887, with an international filing date of Jun. 29, 1999, the disclosure of which is incorporated into this application by reference.

### FIELD OF AND BACKGROUND OF THE INVENTION

The present invention relates to an actuating drive. More specifically, the present invention relates to a window opener drive or a sliding roof drive for a motor vehicle.

European Patent EP 0 360 911 B1, UK Patent Application GB 2 289 351 A, and German utility model DE 92 09 929 U1 teach actuating drives, in particular window opener drives for motor vehicles. Therein, a closing part, in particular a window pane for motor vehicles, is power-operated between an opened position and a closed position by means of an electric motor.

At least one transmission in form of a gear mechanism and/or a cable drive or a scissors-type jack drive, is provided in the power train between the electric motor and the closing part. In the case of a cable drive, the closing part is moved by a cable. The cable is wrapped around and/or wound onto and off a cable drive drum, which is rotated by a driving motor. Thereby, the cable is fed out or in by the cable drive drum, to thereby move the closing part between the opened and closed positions.

German Laid-open publication DE 197 52 973 A1 discloses a window actuating device having a cable drive. Therein, a cable is wound on or unwound from a roller having spiral grooves. To prevent the cable from becoming slack or over-stretched, the roller is composed of two roller parts, which are arranged axially one behind the other. Each of the roller parts has a spiral groove whose depth increases toward their respective axially outer ends.

As the electric motor starts the movement to open the window out of the window's rest position, the electric motor must output an increased power. Likewise, as the window slides into the closed position, which is provided with seals that cause friction, the electric motor must output an increased power. The electric motor must be designed for such an increased power output. However, this increased power output makes it more difficult to comply with strict regulations regarding jamming protection. In particular, when the window or the closing part approaches the closed position, these regulations require that the movement of the closing part must slow down in a very short period of time if an obstacle (such as a finger or an arm) inhibits the closing movement of the closing part.

### OBJECTS OF THE INVENTION

It is one object of the present invention is to ensure more reliable jamming protection for a driving motor, while nonetheless ensuring a good load on the driving motor.

### SUMMARY OF THE INVENTION

As described above, in the case of a constant transmission between the electric motor and the closing part, the electric motor must be designed to output an increased power for a short period of time, in which the closing part slides into the closed position. Therein, the closed position has seals, which cause friction during the slide-in motion of the closing part into the closed position.

According to one formulation of the invention, an actuating drive in a motor vehicle includes a closing part, which is operated over an actuating path between an opened position and a closed position. A driving motor operates the closing part between the opened position and the closed position. Furthermore, a transmission in a power train between the driving motor and the closing part is variable over at least a part of the actuating path of the closing part in order to achieve a substantially constant load on the driving motor over the entire actuating path of the closing part.

In contrast to the constant transmission used in the prior art, the present invention facilitates a variable transmission. This results in a substantially constant load of the driving motor during the motion of the closing part over the entire actuating path. Therefore, in contrast to the constant transmission of the prior art, the electric motor does not have to output an increased power during the sliding motion of the closing part into the closed position.

Initially, the closing motion of the closing part is carried out with a high closing speed. Thereafter, the increased transmission according to the present invention allows for a subsequent lower speed and, as a consequence, a smaller accelerated inert mass of the closing part. Therefore, as another result of the variable transmission according to the present invention, an easier and faster braking of the motion of the closing part is achieved. Hence, an improved jamming protection is ensured.

A variable transmission that is advantageous for a typical window opener drive of a vehicle includes a transmission that is increased when the closing part approaches the closed position. Therein, the transmission is “increased” in comparison to the transmission utilized during the remaining path of motion of the closing part. If the guide receiver and the mounting receiver of the window pane in the door frame of a vehicle is distorted when the window pane slides into the opened position, it is advantageous to provide an increased transmission for the start motion of the window pane out of its opened position as well. This leads to a load alleviation of the driving motor. Thus, a better load on the driving motor over the entire actuating path or adjustment range is achieved. If there are special load requirements for the driving motor, an increased transmission is useful in parts of the adjustment range other than or in addition to the closed position range and/or the opened position range. Such special load requirements occur, for example, if the guidance of the window pane is particularly curved, which results in corresponding frictional resistances.

In the case of an actuating drive having a cable drive in the power train between the driving motor and the closing part, the variable transmission according to the present invention is accomplished in a particularly simple manner. In this case, a cable drive drum drives a cable by winding the cable on or around the cable drive drum or by winding and unwinding the cable onto and from the cable drive drum. The cable drive drum is provided with a spiral cable groove, which runs over the axial length of the cable drive drum. By means of this spiral cable groove, the cable or the cable ends are driven and wound or unwound in an axially progressing manner. Since the spiral groove has varied radial diameters over the axial length of the cable drive drum, a respective variable transmission according to the present invention is accomplished. The transition between the different cable groove diameters is preferably steady but can also be incremental.

### BRIEF DESCRIPTION OF THE DRAWINGS

The invention and further advantageous refinements of the invention in accordance with features of the subclaims are explained in greater detail below with reference to schematically illustrated exemplary embodiments in the drawings, in which:

FIGS. 1-3 show a power-operated window pane of a motor-vehicle in its opened position, in an intermediate central position, and in its closed position, respectively;

FIG. 4 shows an axial side view of a cable drive drum having different cable groove diameters for a variable transmission according to the invention, and having a cable end, which is wound on the cable drive drum or unwound from the cable drive drum, wherein the state of the cable drive drum including the cable end corresponds to the opened position of the window pane according to FIG. 1;

FIG. 5 shows an axial front view of a cable drive drum having different cable groove diameters for a variable transmission according to the invention, and having a cable end, which is wound on the cable drive drum or unwound from the cable drive drum, wherein the state of the cable drive drum including the cable end corresponds to the opened position of the window pane according to FIG. 1;

FIG. 6 shows an axial side view of a cable drive drum having different cable groove diameters for a variable transmission according to the invention, and having a cable end, which is wound on the cable drive drum or unwound from the cable drive drum, wherein the state of the cable drive drum including the cable end corresponds to the intermediate central position of the window pane according to FIG. 2;

FIG. 7 shows an axial front view of a cable drive drum having different cable groove diameters for a variable transmission according to the invention, and having a cable end, which is wound on the cable drive drum or unwound from the cable drive drum, wherein the state of the cable drive drum including the cable end corresponds to the intermediate central position of the window pane according to FIG. 2;

FIG. 8 shows an axial side view of a cable drive drum having different cable groove diameters for a variable transmission according to the invention, and having a cable end, which is wound on the cable drive drum or unwound from the cable drive drum, wherein the state of the cable drive drum including the cable end corresponds to the closed position of the window pane according to FIG. 3; and

FIG. 9 shows an axial front view of a cable drive drum having different cable groove diameters for a variable transmission according to the invention, and having a cable end, which is wound on the cable drive drum or unwound from the cable drive drum, wherein the state of the cable drive drum including the cable end corresponds to the closed position of the window pane according to FIG. 3.

### DETAILED DESCRIPTION OF THE PREFERRED EMBODIMENTS

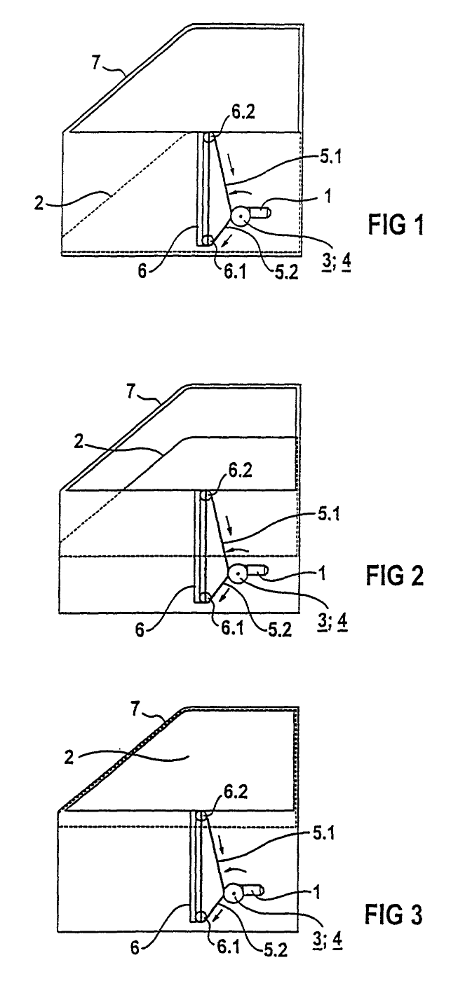

FIGS. 1-3 show three different positions of a motor-vehicle window pane 2, wherein the window pane is moved up and down in a motor-vehicle door frame 7 between a lower opened position (FIG. 1), a central opened position (FIG. 2), and a closed position (FIG. 3). Therein, the movement of the window pane is facilitated by a cable drive or cable drum 3, 4. In order to power-operate the window opener, an electric motor 1 is provided. An electric motor 1 such as the one disclosed, for example, in GB 2 289 351 A drives the cable drum 3 or 4 of the cable drive via a worm gear to allow for the upward and downward movement of the motor-vehicle window pane 2. To this purpose, cable ends 5.1 and 5.2 are either wrapped around the cable drum 3, 4 or are wound on and/or unwound from the cable drum 3, 4. The cable ends 5.1 and 5.2 are coupled to the motor-vehicle window pane 2 via deflecting rolls 6.1 or 6.2 of a guide linkage 6. Thereby, the guide linkage 6 is moved up and down.

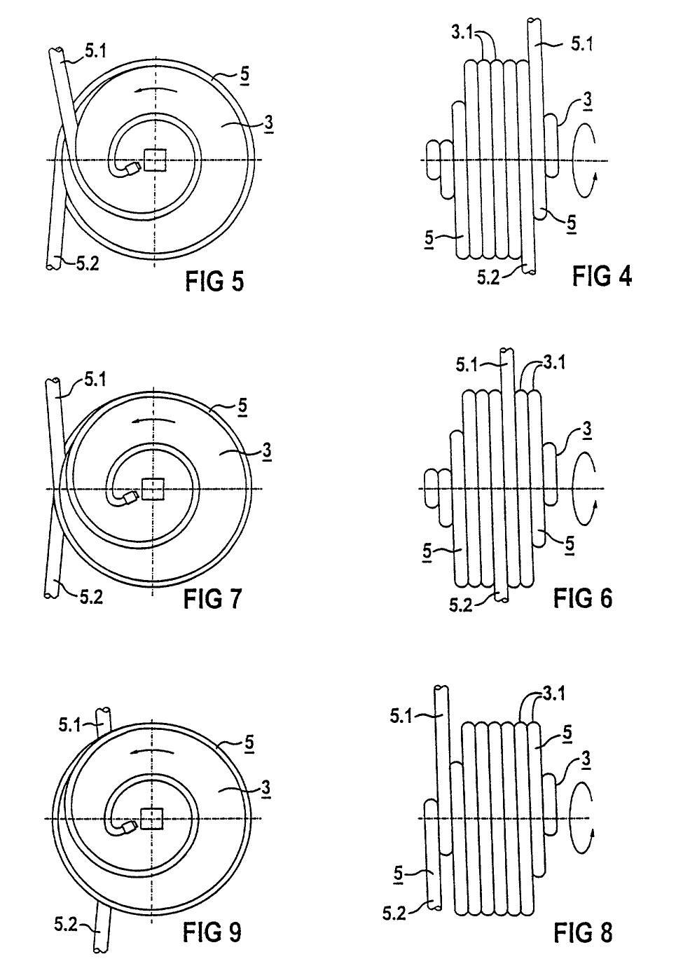

The variable transmission according to the invention results from a simple design of the cable drums 3 and 4. In the following, exemplary embodiments of the invention, which are shown in FIGS. 4-9, are described. These embodiments include a cylindrical cable drum 3, which has variable diameters. Therein, the states of the cable drum 3 and 4, together with the associated cable ends 5.1 and 5.2, correspond to the positions of the window pane shown in FIGS. 1-3.

FIGS. 4, 6, and 8 show an axial side view of the cylindrical cable drum 3, whereas FIGS. 5, 7 and 9 show an axial front view of the cylindrical cable drum 3. The cable drum 3 includes spiral grooves 3.1 around its circumference, which run in an axial direction. Both axial ends of the spiral grooves 3.1. have diameters that are smaller than the diameters of the spiral grooves 3.1. of the remaining portion of the cable drive drum 3. These smaller diameters at both ends of the spiral grooves 3.1. lead to a transmission that is higher than the transmission associated with the spiral grooves 3.1. of the remaining portion of the cable drive drum 3. Cables 5 are wound around the cable drum drive such that they are axially displaced from one another and such that one cable winds and the other unwinds when the cable drum drive is rotated. One end of each of these cables 5 is mounted at the cable drum drive 3, e.g., at a front end thereof. The other ends 5.1 and 5.2 of the cables 5 lead to coupling points of the motor-vehicle window pane 2.

When the cable drum 3 is rotated, one of these cable ends leading to the motor-vehicle window pane 2 is wound up and the other cable end is unwound. This produces an upward and downward movement of the motor-vehicle window pane 2 in the guide linkage 6 and in the motor-vehicle window frame 7.

According to a preferred embodiment of the invention, which is advantageous in terms of manufacturing the actuating device according to the invention, a different transmission is provided at both axial ends of the cable drum 3. This is achieved by the fact that the diameters of the cable grooves 3.1 are smaller at both axial ends than the diameters in the axial central region of the cable drum 3. This results in an increased transmission at both ends of the cable drum 3.

Due to the variable transmission, which is higher when the window pane 2 slides into the more friction-loaded closed position, the driving motor no longer has to be overdimensioned to cope with the resulting higher load. In addition, due to the lower speed of the window pane 2 when approaching the closed position, a rapid braking of the window pane 2 is simplified, which leads to improved jamming protection. In particular, this is necessary when the window pane encounters an obstruction.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. An actuating drive in a motor vehicle, comprising:
a closing part, which is operated over an actuating path between an opened position and a closed position;
a driving motor to operate the closing part between the opened position 210 and the closed position; and
a transmission in a power train between the driving motor and the closing part, wherein the transmission is variable over at least a part of the actuating path of the closing part in order to achieve a substantially constant load on the driving motor over the entire actuating path of the closing part.

2. The actuating drive of claim 1, wherein the actuating drive is a component of at least one of a window opener and a sliding roof drive.

3. The actuating drive of claim 1, wherein the driving motor comprises an electric motor.

4. The actuating drive of claim 1, wherein the transmission has a first ratio in a first portion of the actuating path and a second ratio in a second portion of the actuating path in a vicinity of the closed position, and wherein the second ratio is higher than the first ratio.

5. The actuating drive of claim 1, wherein the transmission has a first ratio in a first portion of the actuating path in a vicinity of the closed position, wherein the transmission has a second ratio in a second portion of the actuating path in a vicinity of the opened position, wherein the transmission has a third ratio in a third portion of the actuating path, and wherein each of the first ratio and the second ratio is higher than the third ratio.

6. The actuating drive of claim 1, further comprising a cable drive between the driving motor and the closing part, wherein the cable drive comprises:
a cable drive drum that is driven by the driving motor; and
a cable that is received by the cable drive drum and that runs on the cable drive drum when the cable drive drum is driven by the driving motor; wherein the cable drive drum varies in diameters in order to effect the variable transmission.

7. The actuating drive of claim 6, further comprising a gear mechanism via which the driving motor drives the cable drive drum; wherein the cable comprises cable ends; and wherein the cable is configured to be wound on or unwound from the cable drive drum.

8. The actuating drive of claim 6, wherein the varied diameters are respective diameters of a spiral groove, which extends axially on a circumference of the cable drive drum and which receives the cable, whereby the cable is axially carried along when it runs on the cable drive drum.

9. The actuating drive of claim 1, comprising an axially cylindrical cable drive drum that varies in diameter to effect the variable transmission.

10. An electromechanical system in a motor vehicle, comprising:
a closing part that moves from a first position to a second position and encounters an increased resistance to movement in a vicinity of the second position;
a cable drum having a spiral recess that extends circumferentially along an axial length of the cable drum and that recedes radially in a predetermined axial portion of the cable drum relative to another axial portion of the cable drum;
a cable received by the recess and operationally interconnected between the closing part and the cable drum; and
a driving motor that rotates the cable drum to move the closing part from the first position to the second position via the cable,
wherein the spiral recess recedes radially in the predetermined axial portion in a manner that counteracts the increased resistance and produces a substantially constant load on the driving motor as the closing part moves from the first position to the second position.

11. The electromechanical system according to claim 10, wherein the second position is a fully closed position of the closing part, and the first position is a position of the closing part intermediate between the fully closed position and a fully open position.

12. The electromechanical system according to claim 10, wherein the second position is a fully open position of the closing part, and the first position is a position of the closing part intermediate between the fully open position and a fully closed position.

13. The electromechanical system according to claim 10, wherein the first position is a first intermediate position between a fully open position and a fully closed position of the closing part, and the second position is a second intermediate position between the fully open position and the fully closed position of the closing part.

14. The electromechanical system according to claim 10, wherein the load on the driving motor varies by less than 10% from a load value of the driving motor in the first position as the closing part encounters the increased resistance.

15. The electromechanical system according to claim 14, wherein the load on the driving motor varies by less than 5% from the load value of the driving motor in the first position as the closing part encounters the increased resistance.

16. An electromechanical system in a motor vehicle, comprising:
a closing part that moves from a first position to a second position and encounters an increased resistance to movement in a vicinity of the second position;
a transmission that changes in transmission ratio in a predetermined portion relative to another portion of the transmission;
a mechanical interconnection between the closing part and the transmission; and
an electric motor that actuates the transmission to move the closing part from the first position to the second position,
wherein the transmission ratio changes in the predetermined portion in a manner that counteracts the increased resistance and produces a substantially constant load on the electric motor as the closing part moves from the first position to the second position.
